(19) United States
(12) Patent Application Publication
(10) Pub. No.: US 2010/0139339 A1
(43) Pub. Date: Jun. 10, 2010

(54) Car door lock

(76) Inventor: Xinkan Hu, Zhongshan (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,849

(22) Filed: Dec. 3, 2009

(30) Foreign Application Priority Data
Dec. 4, 2008 (CN) ZL200820214195.X

(51) Int. Cl. E05B 65/00; B60R 25/00

(52) U.S. Cl. 70/91

(57) ABSTRACT

A car door lock is disclosed. The car door lock comprises: a lock casing; an actuation mechanism mounted on the lock casing; and a press mechanism located outside the lock casing; wherein the door lock further comprises a pull rod extending through the lock casing to connect with the actuation mechanism and the press mechanism, the actuation mechanism enables the opening and closing of the press mechanism via a linear movement of the pull rod. The lock casing is provided with a hole for receiving the pull rod, a protruding platform is formed on the periphery of the hole, the pull rod is provided with a groove for fitting the seal ring, and the seal ring is located within the hole when the pull rod is moved in the hole. The car door lock solves the waterproof problem in positions between the press mechanism and the lock casing.

### TECHNICAL FIELD

The present invention relates to a lock and in particular to a car door lock.

### BACKGROUND OF THE INVENTION

With the car door locks in the prior art, the car door is normally pulled to open after the car door lock is opened. The opening of the car door is realized by the manner that the button drives the actuation rod and finally drives the press mechanism connected to the actuation rod to depart from the car body. The actuation rod is disposed in the lock body casing, and the press mechanism extends through the lock casing to connect with the actuation rod. For the press mechanism should rotate around the joint between it and the actuation rod, a rotation space is required. Therefore, the space between the lock casing and the press mechanism can not be completely sealed, and the waterproof capability in the rotation space is thus weak.

### SUMMARY OF INVENTION

Having outlined the state of the prior art and its attendant shortages, it is an object of the present invention to provide a car door lock which has strong waterproof capability.

The above object of the present invention is achieved by the following technical solutions:

A car door lock comprises: a lock casing; an actuation mechanism mounted on the lock casing; and a press mechanism located outside the lock casing; wherein the door lock further comprises a pull rod extending through the lock casing to connect with the actuation mechanism and the press mechanism, the actuation mechanism enables the opening and closing of the press mechanism via a linear movement of the pull rod, and a seal ring is provided between the pull rod and the lock casing.

Preferably, the pull rod is rotatablely connected to the actuation mechanism and the press mechanism.

Preferably, the lock casing is provided with a hole for receiving the pull rod, a protruding platform is formed on the periphery of the pull rod, the pull rod is provided with a groove for fitting the seal ring, and the seal ring is located within the hole when the pull rod is moved in the hole.

Preferably, the actuation mechanism comprises a button and an actuation rod, the button is positioned on the bottom of the lock casing and rotatablely connected to the bottom of the lock casing, the actuation rod is provided with an free end contacting with the button, the free end is releasable by the rotation of the button, the actuation rod is further provided with a connection end rotatablely connected to the pull rod and with a middle portion rotatablely connected to the bottom of the lock casing, the rotation of the free end enables the rotation of the connection end.

Preferably, a torsion spring is provided between the free end and the lock casing, the torsion spring is in compressed state when the free end of the actuation rod is in contact with the button, the free end of the actuation rod is rotated and released when the button is pressed, and the actuation rod is rotated under spring force.

Preferably, the end face of the free end that is in contact with the button is provided with a stepped surface, the top of the button is an inclined surface, a side of the button that is in contact with the free end is in a shape corresponding to the stepped surface, and a side of the free end facing the bottom of the lock casing is an inclined surface.

Preferably, the press mechanism comprises a connection rod and a locking head, the connection rod is provided with a fixed end rotatablely connected with the lock casing and with a rotation end fixed to the locking head; the pull rod is rotatablely connected with the connection rod to push the connection rod to rotate around the fixed end.

Preferably, the locking head comprises a nut fixed to the rotation end of the connection rod and a screw for engaging with the nut, the length of the screw extending out of the nut is adjustable.

Preferably, the car door lock further comprises a lock core, a portion of the lock casing adjacent to an end of the lock core from which a key is inserted is provided with an inclined groove, the inclined groove extends inwards from the surface of the lock casing, with the gap between the inclined groove and the lock core gradually becoming smaller.

Preferably, the rotatable connection is implemented by a pin connection The pull rod is provided between the actuation mechanism and the press mechanism, and because the movement of the pull rod is linear, the sealing result is better compared with the arrangement that the press mechanism is directly connected with the actuation mechanism due to the curved surface movement between them.

The connections between the pull rod and the actuation mechanism and between the pull rod and the press mechanism are both rotatable connection, which facilitates the up-and-down movement of the pull rod.

The connection between the pull rod and the lock casing is a sealed connection, and for the seal ring of the pull rod is always within the hole, water is further prevented from entering into the hole.

### BRIEF DESCRIPTION OF THE DRAWINGS

FIG. 1 is a schematic sectional view of a car door lock in the closed state according to an embodiment of the present invention;

FIG. 2 is a schematic view of a car door lock in the opened state according to an embodiment of the present invention;

FIG. 3 is a perspective view of a car door lock according to an embodiment of the present invention;

FIG. 4 is a schematic view showing the connection relationship between the pull rod and the hole in the lock casing;

FIG. 5 is a schematic front view of the inclined groove according to an embodiment of the present invention;

FIG. 6 is a schematic sectional view of the inclined groove according to an embodiment of the present invention.

Wherein:

| | |
|---|---|
| 10 | Car door lock |
| 100 | Lock casing |
| 120 | Hole |
| 140 | Inclined groove |
| 200 | Lock body |
| 300 | Button |
| 320 | Inclined surface |
| 340 | Pressure spring |
| 360 | Pin for button |
| 380 | Actuation inclined |
| | surface |
| 400 | Actuation rod |
| 420 | Free end |
| 422 | Stepped surface |
| 430 | Torsion spring |
| 440 | Actuation pin |
| 460 | Connection end |
| 480 | Pin for pull rod |
| 500 | Pull rod |
| 520 | Groove |
| 540 | Seal ring |
| 600 | Press mechanism |
| 620 | Locking head |
| 622 | Nut |
| 624 | Screw |
| 640 | Connecting rod |
| 642 | Fixed end |
| 644 | Locking pin |
| 646 | Rotation end |
| 20 | Car body |
| 30 | Car door |

### DETAILED DESCRIPTION OF THE PREFERRED EMBODIMENT

Many aspects of the invention can be better understood in the following embodiments with reference to the accompanying drawings.

The waterproof and sealing problem can be well solved by adding the pull rod which is in vertical movement between the pull rod and the press mechanism.

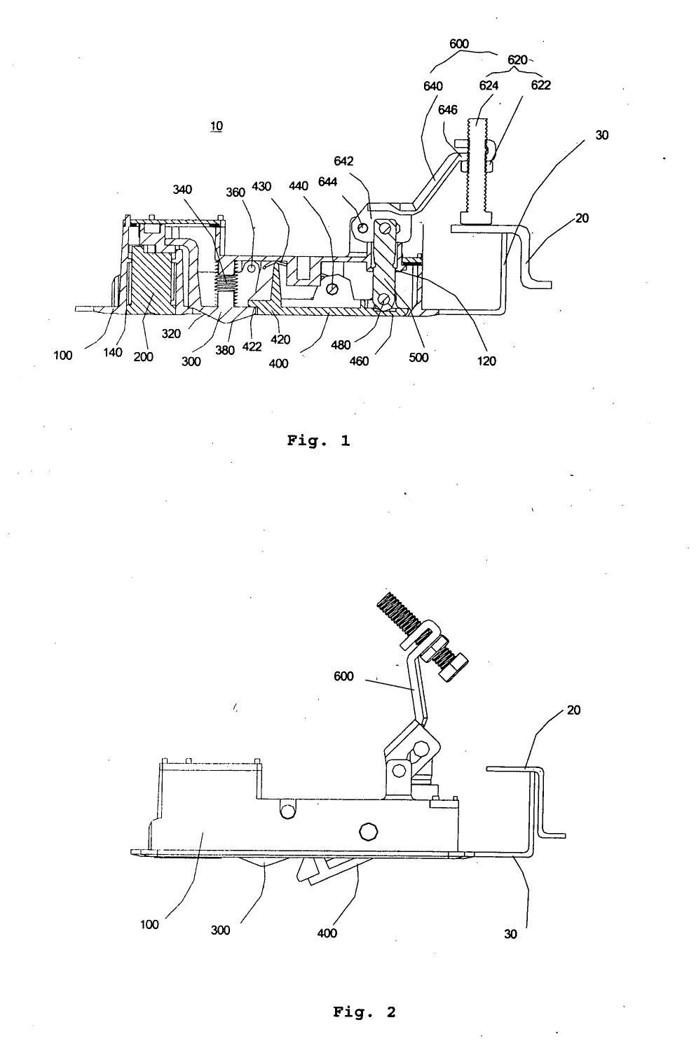

Referring to FIG. 1, the car door lock 10 is mounted on the car door 30, and when the car door 30 is closed, the car door lock 10 locks the car body 20. The car door lock 10 comprises a lock casing 100, a lock core 200, an actuation mechanism, a pull rod 500 and a press mechanism 600. The lock casing 100, the lock core 200 and the actuation mechanism are positioned in the lock casing 100, and the pull rod 500 extends through the lock casing 100 to connect with the actuation mechanism. When the press mechanism 600 is buckled on the car body 20, the car door 30 can not be opened. When the press mechanism 600 is released from the car body 20, the car door 30 is openable.

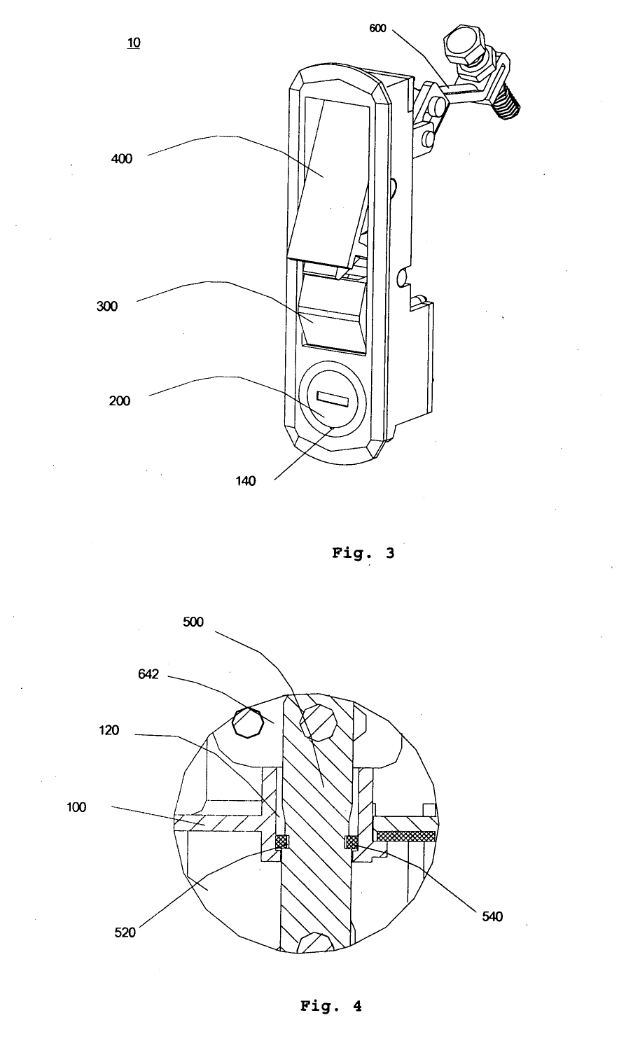

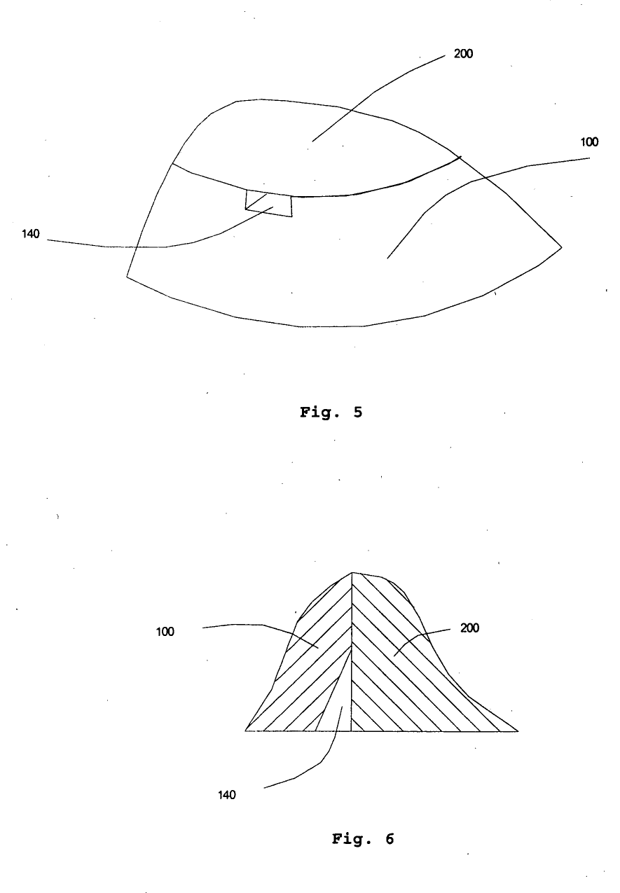

The lock core 200 is mounted in the lock casing 100. The end of the lock core 200 for inserting a key is exposed from the lock casing 100, while the surface of this end of the lock core 200 adjacent to the outer surface is an inclined surface, and rainwater can be discharged along the inclined surface. In other embodiments, as shown in FIG. 1 and FIG. 3, a portion of the lock casing 100 adjacent to an end of the lock core 200 from which a key is inserted is provided with an inclined groove. As shown in FIG. 5 and FIG. 6, the inclined groove 140 extends inwards from the surface of the lock casing 100, with the gap between the inclined groove and the lock core 200 gradually becoming smaller. The position of the inclined groove 140 is determined according to the installation manner of the car door lock 10, and preferably at the lowest point in vertical height of the contact portion between the lock core 200 and the lock casing 100, so that the rainwater which enters into the lock casing 100 can gather to the inclined groove 140 under the gravity and automatically discharged along the inclined groove 140 to avoid the lock core 200 from being corroded due to the deposit of rainwater.

The actuation mechanism comprises a button 300 and an actuation rod 400. The button 300 is adjacent to the lock core 200, and the top of the button is a splay inclined surface and contacts with the lock core 200 at the inclined surface 320. The bottom of the button 300 is set on the bottom of the lock casing 100 via the pressure spring 340, and the button 300 is further mounted to the bottom of the lock casing 100 via a pin 360 and rotatable around the pin 360. The actuation inclined surface 380 of the top of the button 300 is in contact with the actuation rod 400.

The free end 420 of the actuation rod 400 is in contact with the actuation inclined surface 380. The free end 420 of the actuation rod 400 is provided with a stepped surface 422, and the inclined surface 380 of the button 300 is pressed against the stepped surface 422 of the actuation rod 400. A torsion spring 430 is provided between the free end 420 and the lock casing 100, the torsion spring 430 is in compressed state when the button 300 presses against the stepped surface 422 of the actuation rod 400. The side of the free end 420 of the actuation rod 400 facing the bottom of the lock casing 100 is an inclined surface.

The middle portion of the actuation rod 400 is connected to the bottom of the lock casing 100 by a pin 440. The connection end 460 of the actuation rod 400 is connected to the pull rod 500 via a pin 480.

Other structures may also be used in the button 300 and the actuation rod 400 as long as the pull rod 500 can be driven to perform a linear movement by pressing the button 300.

Referring to FIG. 4, the bottom of the lock casing 100 is provided with a hole 120. One end of the pull rod 500 is connected to the actuation rod 400, while the other end extends through the hole 120 to connect with the press mechanism 600. Waterproof treatment is carried out to the portion between the pull rod 500 and the hole 120. Because the pull rod 500 is moved along the hole 120, a seal ring can be provided in this position. In order to improve the sealing and waterproof result, in other embodiments, as shown in FIG. 1 and FIG. 4, a protruding platform is formed on the periphery of the hole, forming a columnar hole. The pull rod 500 is provided with a groove 520 for fitting the seal ring 540, and the seal ring 540 is in interference fit with the inner wall of the hole 120. When the pull rod 500 is moved up and down in the hole 120, the seal ring always follows the movement. The position of the pin 440 and the height of the columnar hole 120 is adjusted to allow the seal ring is always within the hole 120 during the movement of the pull rod 500. Even if water enters into the position of the pull rod 500, it can not enter into the inside of the car through the hole 120. In other embodiments, a protruding platform having other shape may also be formed on the periphery of the hole 120 as long as the shape is corresponding to that of the pull rod 500 and the pull rod 500 can perform a linear movement therein.

Referring to FIG. 1, the press mechanism 600 is located outside the lock casing 100, and comprises a locking head 620 and a connecting rod 640. The fixed end 642 of the connecting rod 640 is connected to the lock casing 100 via the locking pin 644 and is rotatable around the locking pin 644; the rotation end 646 is fixed to the locking head 620. At the portion of the connecting rod 620 near the locking pin 644, the connecting rod 640 is rotatablely connected to the pull rod 500. The locking head 620 comprises a nut 622 fixed to the rotation end 646 of the connection rod and a screw 624 for engaging with the nut 622. The length of the screw 624 extending out of the nut 622 is adjustable.

In the above structure, seal rings are provided around the rotation pins and the pull rod 500, and a seal washer is provided on the bottom of the lock casing 100 to be impervious to water thoroughly.

The operation process is as follows:

To open the car door, a key is used to open the lock core 200, and the car door 30 is pulled to open. During opening the car door, the button 300 is firstly pressed down (before the lock core 200 is opened by the key, the lock core 200 can not be pressed down, structures for realizing such function are well known, no more details here). For the top of the button 300 is a splay inclined surface, it is convenient to press the button 300 towards the lock head 200. Because the surface of the button 300 contacting with the lock casing 100 is an inclined surface 320, the button 300 can overcome the pressure spring 340 to rotate around the pin 360 in clockwise direction. At this time, the actuation inclined surface 380 of the top of the button 300 is uplifted to leave the stepped surface 422 of the free end 420 of the actuation rod 400. The torsion spring 430 releases spring force, the free end 420 is rotated around the pin 440 in counterclockwise direction, the connection end of the actuation rod 400 connected to the pull rod 500 also rotates in counterclockwise direction to push the pull rod 500 to move towards the press mechanism 600. The connection rod 640 is rotated around the locking pin 642 in counterclockwise direction, and the locking head 620 fixed to the connection rod 640 leaves the car body 20 (as shown in FIG. 2), and the car door 30 can be opened accordingly. After the car door 30 is opened, the force acted on the button 200 is released, and the button 200 is reset.

When closing the car door, the car door 30 is closed, and then the car door lock is locked. After the car door 300 is closed, since the side of the free end 420 facing the bottom of the lock casing 100 is an inclined surface, the inclined surface of the free end 420 gradually glides over the end face of the button 300 after the free end 420 of the actuation rod 400 is pressed down, until it reaches the stepped surface 422, then end face of the button 300 is engaged with the stepped surface 422 and stops gliding, and at this time the torsion spring 430 is compressed. While the free end 420 of the actuation rod 400 is rotatively pressed down in clockwise direction, the connection end 460 is also rotated around the pin 440 in clockwise direction and drives the pull rod 500 to move apart from the press mechanism 600. Under the driving of the pull rod 500, the connection rod 640 is rotated around the pin 644 in clockwise direction, and the locking head 620 presses out the car body 20 (as shown in FIG. 1), then the door 30 is locked by locking the lock core 200. The length of the screw 624 extending out of the nut 622 is adjustable to ensure the locking head 620 to flatly press on the car body 20.

For the pull rod 500 is provided, the movement of the pull rod 500 in the hole 120 of the lock casing 100 is a linear movement, the waterproof and sealing result with respect to the joint in the linear movement is better than that with respect to the joint in the curved surface movement.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

What is claimed is:

1. A car door lock, comprising:
a lock casing;
an actuation mechanism mounted on the lock casing; and
a press mechanism located outside the lock casing;
wherein the door lock further comprises a pull rod extending through the lock casing to connect with the actuation mechanism and the press mechanism, the actuation mechanism enables the opening and closing of the press mechanism via a linear movement of the pull rod, and a seal ring is provided between the pull rod and the lock casing.

2. The car door lock of claim 1, wherein the pull rod is rotatablely connected to the actuation mechanism and the press mechanism.

3. The car door lock of claim 1, wherein the lock casing is provided with a hole for receiving the pull rod, a protruding platform is formed on the periphery of the hole, the pull rod is provided with a groove for fitting the seal ring, and the seal ring is located within the hole when the pull rod is moved in the hole.

4. The car door lock of claim 1, wherein the actuation mechanism comprises a button and an actuation rod, the button is set on the bottom of the lock casing and rotatablely connected to the bottom of the lock casing, the actuation rod is provided with an free end contacting with the button, the free end is releasable by the rotation of the button, the actuation rod is further provided with a connection end rotatablely connected to the pull rod and with a middle portion rotatablely connected to the bottom of the lock casing, the rotation of the free end enables the rotation of the connection end.

5. The car door lock of claim 4, wherein a torsion spring is provided between the free end and the lock casing, the torsion spring is in compressed state when the free end of the actuation rod is in contact with the button, the free end of the actuation rod is rotated and released when the button is pressed down, and the actuation rod is rotated under spring force.

6. The car door lock of claim 5, wherein the end face of the free end that is in contact with the button is provided with a stepped surface, the top of the button is an inclined surface, a side of the button that is in contact with the free end is in a shape corresponding to the stepped surface, and a side of the free end facing the bottom of the lock casing is an inclined surface.

7. The car door lock of claim 1, wherein the press mechanism comprises a connection rod and a locking head, the connection rod is provided with a fixed end rotatablely connected with the lock casing and with a rotation end fixed to the locking head; the pull rod is rotatablely connected with the connection rod to push the connection rod to rotate around the fixed end.

8. The car door lock of claim 7, wherein the locking head comprises a nut fixed to the rotation end of the connection rod and a screw for engaging with the nut, the length of the screw extending out of the nut is adjustable.

9. The car door lock of claim 1, wherein the car door lock further comprises a lock core, a portion of the lock casing adjacent to an end of the lock core from which a key is inserted is provided with an inclined groove, the inclined groove extends inwards from the surface of the lock casing, with a gap between the inclined groove and the lock core gradually becoming smaller.

10. The car door lock of claim 2 or 4 or 7, wherein the rotatable connection is implemented by a pin connection.
